(19) United States
(12) Patent Application Publication
(10) Pub. No.: US 2020/0398456 A1
(43) Pub. Date: Dec. 24, 2020

(54) ADDITIVELY-MANUFACTURED STRUCTURE FOR REACTIONARY PROCESSES

(71) Applicant: The Curators of the University of Missouri, Columbia, MO (US)

(72) Inventors: Fateme Rezaei, Rolla, MO (US); Ali Rownaghi, US, MO (US); Shane Lawson, Rolla, MO (US)

(21) Appl. No.: 16/908,093

(22) Filed: Jun. 22, 2020

Related U.S. Application Data
(60) Provisional application No. 62/865,478, filed on Jun. 24, 2019.

(51) Int. Cl. B28B 1/00; B33Y 10/00; B33Y 80/00; B33Y 70/00; B29C 64/165; B01D 53/86; B01J 35/00; B01J 37/02; B01J 20/32

(52) U.S. Cl. CPC B28B 1/001; B33Y 10/00; B33Y 80/00; B33Y 70/00; B33Y 30/00; B01D 53/86; B01J 35/004; B01J 37/0215; B01J 20/32; B29C 64/165

(57) ABSTRACT

A method of additively manufacturing a multi-material structure for a reactionary process includes forming a first material from a first binder and a first active agent and depositing a first layer including the first material onto a build platform. The method also includes forming a second material from a second binder and a second active agent and depositing a second layer including the second material onto the build platform. The second material is in contact with the first material. The method further includes adhering the second material to the first material to form the multi-material structure for use in the reactionary process. The first material provides a first reaction during the reactionary process and the second material provides a second reaction during the reactionary process. In addition, a method of additively manufacturing a binderless structure for a separation process includes binding a material to organic biopolymers and step-wise calcination to burn the organic components and sinter the particles for forming 100% pure material.

### CROSS-REFERENCE TO RELATED APPLICATIONS

This application claims the benefit of priority to U.S. Provisional Patent Application No. 62/865,478, filed Jun. 24, 2019, the entire contents and disclosure of which are hereby incorporated by reference.

### BACKGROUND OF THE DISCLOSURE

The subject matter described herein relates generally to structures for reactionary processes and, more particularly, to structures for reactionary processes that are formed using additive manufacturing processes.

Structures designed for reactionary processes typically include a material that interacts with a reactant to provide a desired chemical process or reaction. For example, some structures include metal-organic frameworks (MOF) or other materials that are used for adsorption and catalytic processes. Sometimes the structures are formed using an additive manufacturing process. In typical additive manufacturing processes, a structure is formed by depositing a material in a series of layers and treating or consolidating the layers to form a solid structure. The additive manufacturing process may be less expensive and take less time than other processes to form the structures. In addition, the additive manufacturing process may provide greater control and precision of characteristics of the structure such as shape, size, and material properties.

Sometimes, it is desirable for a structure to have characteristics of more than one material and/or to provide more than one chemical process when exposed to reactants. However, conventional systems may not be able to incorporate materials having different characteristics or reactionary tendencies into a single structure. For example, some materials may not properly bind together if included in the same structure and/or may require different consolidation or treatment processes. In addition, the materials could react with each other during and/or after the manufacturing process. Accordingly, structures for adsorption and catalytic processes are typically formed from a single material. Therefore, separate structures may be required to provide more than one chemical process and the cost and time required to manufacture structures for reactionary processes may be increased. In addition, it may not be possible to provide structures for multiple catalyst or adsorption processes in some applications.

### BRIEF DESCRIPTION OF THE DISCLOSURE

In one aspect, a method of additively manufacturing a multi-material structure is provided. The method includes forming a first material from a first binder and a first active agent and depositing a first layer including the first material onto a build platform. The method also includes forming a second material from a second binder and a second active agent and depositing a second layer including the second material onto the build platform. The second material is in contact with the first material. The method further includes adhering the second material to the first material to form a multi-material structure for use in a reactionary process. The first material provides a first reaction during the reactionary process and the second material provides a second reaction during the reactionary process.

In another aspect, an additively manufactured multi-material structure for use in a reactionary process is provided. The multi-material structure includes a first layer including a first material formed from a first binder and a first active agent and a second layer including a second material formed from a second binder and a second active agent. The second material is in contact with and adhered to the first material. The first material provides a first reaction during the reactionary process and the second material provides a second reaction during the reactionary process.

In yet another aspect, a method of using an additively manufactured multi-material structure is provided. The method includes providing a multi-material structure constructed of a plurality of layers. The multi-material structure includes a first material and a second material in contact with and adhered to the first material. The method also includes channeling a fluid flow including at least one reactant through the multi-material structure such that the first material and the second material are exposed to the reactant. The first material causes a first reaction and the second material causes a second reaction when the fluid flow is directed through the multi-material structure.

In still another aspect, a method of additively manufacturing a structure is provided. The method includes forming a material from a binder and an active agent and depositing at least one layer including the material onto a build platform. The method also includes heating the at least one layer to calcine the binder in the material and form a structure for use in a reactionary process. The material provides a reaction during the reactionary process.

In yet another aspect, an additively manufactured binderless structure for use in a reactionary process is provided. The binderless structure includes at least one layer including a material formed from a calcined binder and an active agent. The material provides a reaction during the reactionary process.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a schematic diagram of an exemplary embodiment of an additive manufacturing system for forming a structure.

FIG. 2 is a flow chart of an example method of fabricating a multi-material structure for use in a reactionary process.

FIG. 3 is a top view of a multi-material structure formed using an additive manufacturing system.

FIG. 4 is a perspective view of the multi-material structure shown in FIG. 3.

FIG. 5 is a top view of a binderless structure formed using an additive manufacturing system.

FIG. 6 is a flow chart of an example method of fabricating a binderless multi-material structure for use in a reactionary process.

FIG. 7 is a graph comparing carbon dioxide adsorption capacity to pressure for zeolite 13X materials.

FIG. 8 is a graph comparing carbon dioxide adsorption capacity to pressure for zeolite 5A materials.

FIG. 9 is a graph comparing carbon dioxide adsorption capacity to pressure for H-ZSM-5 materials.

FIG. 10 is a graph comparing dinitrogen adsorption capacity to pressure for zeolite 13X materials.

FIG. 11 is a graph comparing dinitrogen adsorption capacity to pressure for zeolite 5A materials.

FIG. 12 is a graph comparing dinitrogen adsorption capacity to pressure for H-ZSM-5 materials.

FIG. 13 is a graph comparing methane adsorption capacity to pressure for zeolite 13X materials.

FIG. 14 is a graph comparing methane adsorption capacity to pressure for zeolite 5A materials.

FIG. 15 is a graph comparing methane adsorption capacity to pressure for H-ZSM-5 materials.

FIG. 16 is a graph of normalized CO₂ uptakes for different zeolite 13X adsorbents.

FIG. 17 is a top view of a binderless multi-material structure formed using an additive manufacturing system.

FIG. 18 is a perspective view of the binderless multi-material structure shown in FIG. 17.

FIG. 19 is a flow chart of an example method of fabricating a binderless multi-material structure for use in a reactionary process.

FIG. 20 is a bar graph showing different reactionary properties for a binderless multi-material structure.

### DETAILED DESCRIPTION OF THE DISCLOSURE

As used herein, the term “reactionary process” refers to a process that occurs when at least one active agent is exposed to at least one reactant. For example and without limitation, reactionary processes include catalytic processes, adsorption processes, and photocatalytic processes.

In this disclosure, systems and methods for additively manufacturing single-material and multi-material structures are described. For example, the multi-material structures may include two or more materials that have different properties. In some embodiments, the structures may be binderless and include a material formed from a calcined binder and an active agent. For example, a method of additively manufacturing a binderless structure for a separation process includes binding a material to organic biopolymers and step-wise calcination to burn the organic components and sinter the particles for forming 100% pure material. The structures may be used for reactionary process such as adsorption and/or catalytic processes. The structures may provide improved performance (e.g., increased adsorption or a more efficient catalytic conversion) in comparison to known structures for reactionary processes. In addition, the multi-material structures may allow for simultaneous reactions of different reactants during the reactionary processes because the structures include multiple materials having distinct properties.

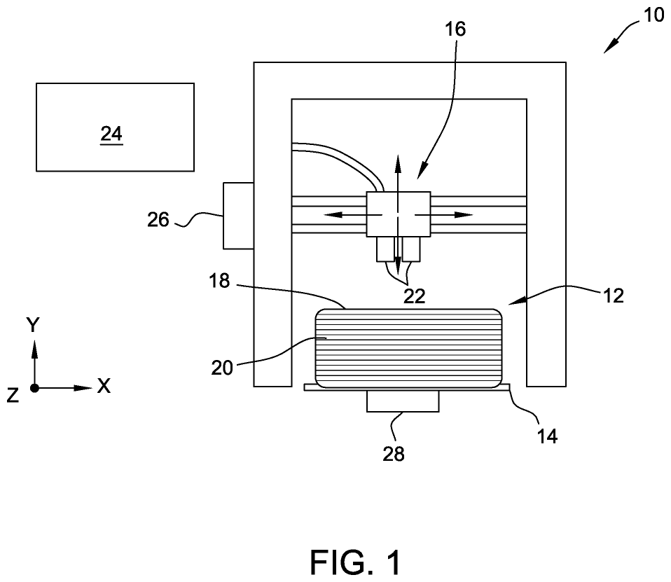

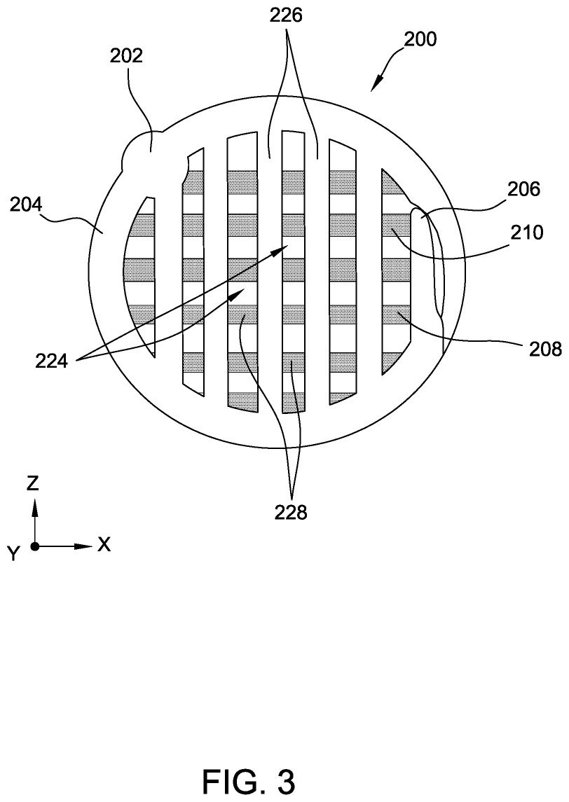

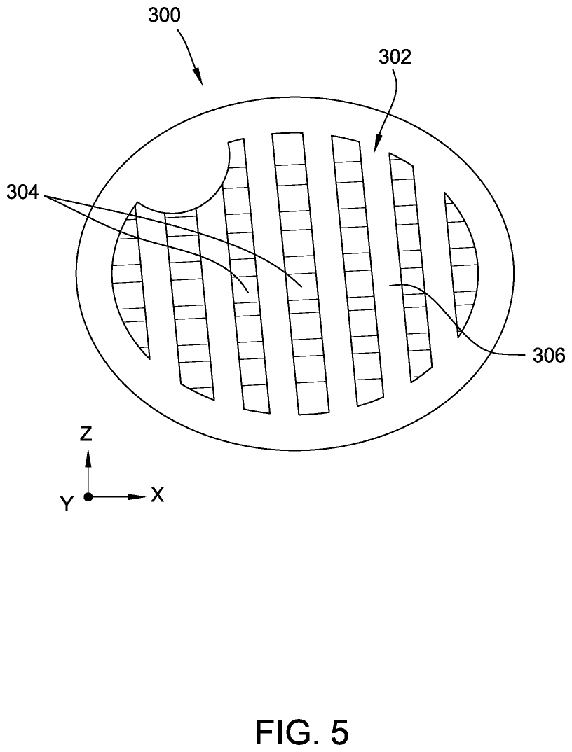

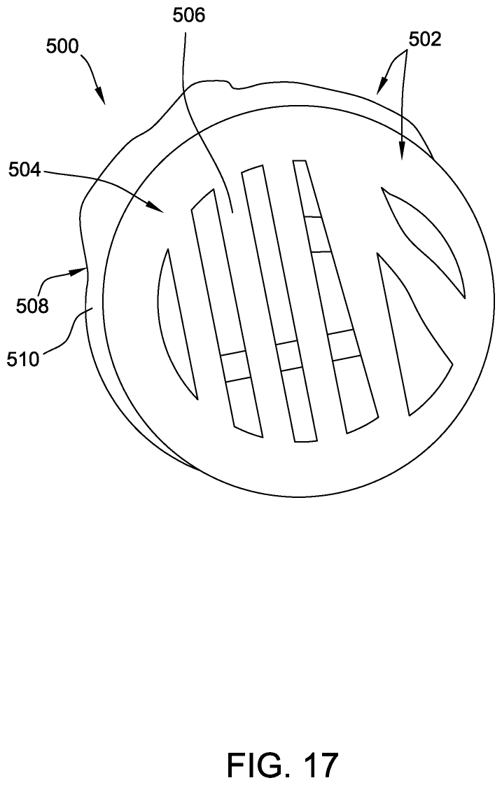

FIG. 1 is a schematic diagram of an exemplary embodiment of an additive manufacturing system 10 for forming a structure such as a multi-material structure 12, a multi-material structure 200 (shown in FIG. 3), a binderless structure 300 (shown in FIG. 5), and a binderless multi-material structure 500 (shown in FIG. 17). The additive manufacturing system 10 includes a build platform 14 and a material dispenser 16. In some embodiments, the additive manufacturing system 10 includes a consolidation device, such as a heat source or a binder jet, configured to consolidate the material dispensed by the material dispenser 16.

The material dispenser 16 is configured to dispense one or more materials 18, 20 onto the build platform 14. For example, the material dispenser 16 may dispense a first material 18 and a second material 20 in a series of layers. In addition, the material dispenser 16 may dispense the materials 18, 20 in a desired pattern on the build platform 14. Also, in some embodiments, the additive manufacturing system 10 may include a recoater assembly configured to distribute the materials 18, 20 across the build platform 14.

The materials 18, 20 dispensed by the material dispenser 16 may be any materials suitable for forming the multi-material structure 12. In some embodiments, each material 18, 20 includes a binder that causes the material to solidify, i.e., cure, as the multi-material structure 12 is exposed to the environment. In further embodiments, the additive manufacturing system 10 may include a heat source to at least partially control the curing of the material 18, 20.

In the illustrated embodiment, the material dispenser 16 includes a plurality of nozzles 22. Each nozzle 22 is configured to dispense one of the materials 18, 20 onto the build platform 14. Accordingly, the material dispenser 16 is configured to dispense a plurality of materials 18, 20 onto the build platform 14. In other embodiments, at least one nozzle 22 may be configured to dispense more than one material. For example, at least one of the nozzles 22 may be coupled to a plurality of material supplies and a valve or control device may control which material(s) are supplied to the nozzles. In alternative embodiments, the material 18, 20 may be provided to the build platform 14 in any suitable manner. For example, in some embodiments, the material 18, 20 is transferred from a hopper to the build platform 14 using a recoater assembly.

During operation of the additive manufacturing system 10, the material dispenser 16 is operated to deposit the first and second materials 18, 20 onto the build platform in a series of layers. Specifically, the first nozzle 22 of material dispenser 16 deposits a first material 18 onto the build platform 14 in a first layer. The second nozzle 22 deposits a second material 20 onto or adjacent the first material 18 on the build platform 14 in a second layer. Additive manufacturing system 10 repeatedly deposits the materials 18, 20 in the layers until the multi-material structure 12 includes a desired number of layers.

In the exemplary embodiment, the first material 18 and the second material 20 each include binders that cause the materials to solidify, i.e., cure, as the multi-material structure 12 is exposed to the environment. For example, in some embodiments, the materials 18, 20 are each formed by mixing an active agent in a solvent including the respective binder and thereby forming a paste. The first material 18 and the second material 20 are able to be extruded and deposited on the build platform 14 in the paste form. In addition, the first material 18 and the second material 20 are configured to adhere together when the materials contact each other. For example, in some embodiments, the binder in the first material 18 and/or the binder in the second material 20 adheres to the other of the first material and the second material. The materials form a solid, contiguous structure when the materials cure. In alternative embodiments, the first material 18 and the second material 20 are adhered together in any suitable manner. For example, in at least some embodiments, a separate binder material is deposited between the first material 18 and the second material 20.

Also, during operation of the additive manufacturing system 10, the material dispenser 16 is configured to move in vertical and horizontal directions (X-direction and Y-direction) relative to the build platform 14 in reference to the orientation of the additive manufacturing system 10 shown in FIG. 1. In addition, the build platform 14 is configured to move in a horizontal direction (Z-direction) relative to the material dispenser 16. Accordingly, the material dispenser 16 is able to deposit the materials in desired patterns and shapes on the build platform 14 and deposit the materials in a series of layers. In alternative embodiments, the build platform 14 may be moved in the vertical direction (Y-direction) relative to the material dispenser 16 when the material dispenser 16 deposits the layers of the materials 18, 20.

Moreover, in the exemplary embodiment, the additive manufacturing system 10 may include a computer control system, or controller 24. For example, the controller 24 may include a processor, a memory, and a user interface including an input device and a display. The controller 24 may control operation of components of the additive manufacturing system 10, such as one or more actuator systems 26, 28 and the material dispenser 16, to fabricate the multi-material structure 12. For example, the controller 24 controls the amount of the material 18, 20 that is dispensed through each nozzle 22 of the material dispenser 16.

In the exemplary embodiment, the additive manufacturing system 10 is operated to fabricate the multi-material structure 12 from a computer modeled representation of the 3D geometry of the component. The computer modeled representation may be produced in a computer aided design (CAD) or similar file. The CAD file of the multi-material structure 12 is converted into a format that includes a plurality of build parameters for one or more layers of the multi-material structure 12. In the exemplary embodiment, the multi-material structure 12 is modeled in a desired orientation relative to the origin of the coordinate system used in the additive manufacturing system 10. The geometry of the multi-material structure 12 is sliced into one or more layers. Once the process is completed, an electronic computer build file (or files) is generated, including all of the layers. The build file is loaded into the controller 24 of the additive manufacturing system 10 to control the system during fabrication of each layer.

After the build file is loaded into the controller 24, the additive manufacturing system 10 is operated to generate the multi-material structure 12 by implementing the additive manufacturing process. The exemplary additive manufacturing process does not use a pre-existing article as the precursor to the final structure, rather the process produces structures from a raw material in a configurable form, such as particulate or paste. Additive manufacturing system 10 enables fabrication of structures using a broad range of materials, for example, and without limitation, metals, ceramics, glass, and polymers.

Moreover, in the exemplary embodiment, during operation of the additive manufacturing system 10, the controller 24 is able to control the operation of the actuator system 26, 28 to adjust the height and position of the material dispenser 16 and/or the build platform 14. In the exemplary embodiment, the material dispenser 16 is moved vertically and horizontally using the actuator system 26. In addition, the build platform 14 is moved horizontally using the actuator system 28. In alternative embodiments, the material dispenser 16 and/or the build platform 14 is moved in any manner that enables the additive manufacturing system 10 to operate as described herein.

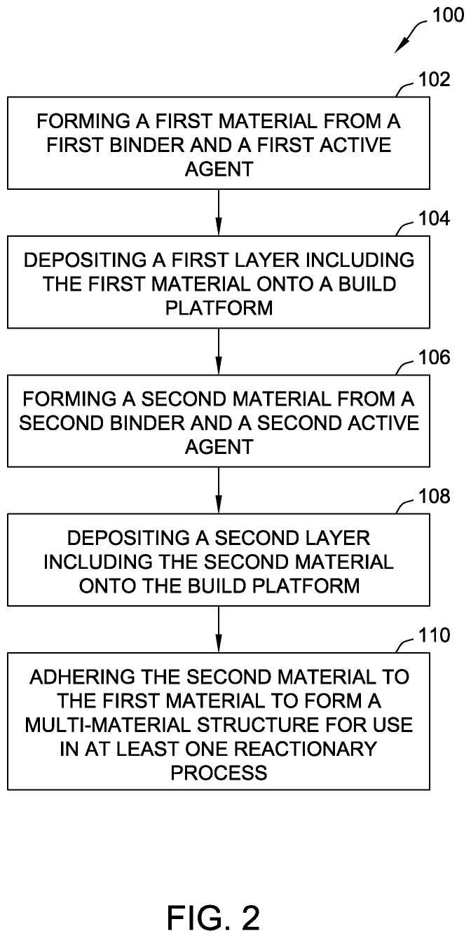

FIG. 2 is a flow chart of an example method 100 of fabricating the multi-material structure 12. With reference to FIGS. 1 and 2, the method 100 includes forming 102 the first material 18 from a first binder and a first active agent. For example, in some embodiments, the first material 18 is formed by mixing the first active agent in a solvent including the binder to form a paste. Method 100 includes depositing 104 a first layer including the first material 18 onto the build platform 14. In some embodiments, the first layer is deposited in a desired shape such as a grid pattern on the build platform 14.

In addition, the method 100 also includes forming 106 the second material 20 from a second binder and a second active agent. For example, in some embodiments, the second material 20 is formed by mixing the second active agent in a solvent including the binder to form a paste. Method 100 includes depositing 108 a second layer including the second material 20 onto the build platform 14. In some embodiments, the second layer is deposited in a desired shape such as a grid pattern on the build platform 14. The second material 20 is deposited on the build platform 14 such that the second material 20 is in contact with the first material 18. For example, the second material 20 may be deposited in a layer on top of the first material 18. In some embodiments, the second material 20 may be deposited in the same layer as the first material 18. The first material 18 and the second material 20 are selected to be compatible with each other, e.g., the first and second materials do not react to each other when the materials are in contact.

The method 100 further includes adhering 110 the second material 20 to the first material 18 to form a multi-material structure for use in at least one reactionary process. For example, the first binder in the first material 18 may be configured to adhere to the second material 20 when the second material contacts the first material. In alternative embodiments, the second material 20 is adhered to the first material 18 in any manner that enables the multi-material structure 12 to function as described herein.

In some embodiments, the method 100 includes heat treating the multi-material structure 12 after adhering 110 the second material 20 to the first material 18. Heat treating the multi-material structure 12 may control the curing process for the first material 18 and the second material 20. When the first material 18 and the second material 20 are cured the multi-material structure 12 may be a solid monolith structure. In addition or alternatively, heat treating the multi-material structure 12 may provide a desired characteristic to the multi-material structure 12 such as a hardness. In alternative embodiments, the multi-material structure 12 may undergo any suitable treatment processes.

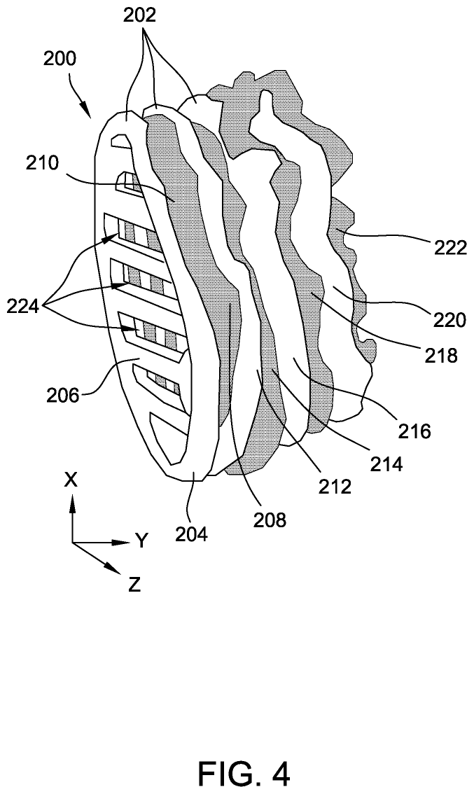

FIG. 3 is a top view of a multi-material structure 200 formed using an additive manufacturing system. FIG. 4 is a perspective view of the multi-material structure 200. The multi-material structure 200 includes a plurality of layers 202 and two or more different materials. Accordingly, the multi-material structure 200 is able to provide simultaneous reactions when exposed to at least one reactant. As a result, the multi-material structure 200 is configured for use in reactionary processes involving multiple reactions and is able to provide multiple reactions when the multi-material structure is exposed to one or more reactants.

The multi-material structure 200 includes a plurality of materials in a plurality of layers 202. For example, the multi-material structure 200 includes a first layer 204 including a first material 206 formed from a first binder and a first active agent, and a second layer 208 including a second material 210 formed from a second binder and a second active agent. In addition, the multi-material structure 200 includes a third layer 212, a fourth layer 214, a fifth layer 216, a sixth layer 218, a seventh layer 220, and an eighth layer 222. In the exemplary embodiment, each layer 202 includes the first material 206 or the second material 210. Specifically, the materials 206, 210 in the layers 202 are arranged in an alternating pattern (e.g., the first, third, fifth, and seventh layers include the first material 206, and the second, fourth, sixth, and eighth layers include the second material 210). In the illustrated embodiment, the multi-material structure 200 includes eight layers. In alternative embodiments, the multi-material structure 200 may include any layer that enables the multi-material structure to function as described herein. For example, in some embodiments, the multi-material structure 200 includes at least one layer including a third material formed from a third binder and a third active agent. In further embodiments, at least one of the layers 202 includes the first material 206 and the second material 210.

The layers 202 are arranged in a stacked configuration such that the material of each layer 202 is in contact with and adhered to the material of an adjacent layer(s) 202 (i.e., each layer 202 contacts a layer that is above or below the layer). In the exemplary embodiment, the materials 206, 210 are adhered together such that the layers 202 are permanently joined together, i.e., the layers 202 cannot be separated without damaging the multi-material structure 200. Accordingly, the multi-material structure 200 is a monolith and may be more durable than other structures that include separate components attached together. In addition, the multi-material structure 200 may be more compact than at least some known structures for reactionary processes. Moreover, the multi-material structure 200 may provide nearly simultaneous exposure of both the first material 206 and the second material 210 to one or more reactants because of the layered configuration of the multi-material structure 200.

The multi-material structure 200 is configured to provide multiple reactions when the multi-material structure 200 is exposed to at least one reactant. For example, the first material 206 has a first property that provides a first reaction during the at least one reactionary process. The first reaction is caused by the first active agent in the first material 206 being exposed to a reactant. For example, in some embodiments, the first agent is configured to absorb at least one reactant during the at least one reactionary process. In further embodiments, the first active agent is configured to provide a catalytic conversion of at least one reactant during the at least one reactionary process. In alternative embodiments, the first material 206 provides any reaction that enables the multi-material structure 200 to function as described herein.

The second material 210 has a second property that provides a second reaction during the at least one reactionary process. The second reaction is caused by the second active agent in the second material 210 being exposed to a reactant. For example, in some embodiments, the second agent is configured to absorb at least one reactant during the at least one reactionary process. In further embodiments, the second active agent is configured to provide a catalytic conversion of at least one reactant during the at least one reactionary process.

In some embodiments, the multi-material structure 200 is a photocatalyst and at least one of the first material 206 and the second material 210 is configured to interact with light. In alternative embodiments, the multi-material structure 200 provides any reaction that enables the multi-material structure 200 to function as described herein.

In further embodiments, the multi-material structure 200 is constructed for use in a multi-component adsorption process. For example, the multi-material structure 200 may be configured to receive a fluid flow including at least three gasses and process the fluid flow to remove at least two of the gasses. Specifically, the first material 206 may be configured to absorb a first gas from the fluid flow and the second material 210 may be configured to absorb a second gas from the fluid flow. Accordingly, a third gas will be left in the fluid flow after reactions with the multi-material structure 200. The first and second gasses may be removed from the multi-material structure 200 by temperature control or any other suitable desorption process.

Each layer 202 of the multi-material structure 200 has a lattice or grid shape and defines a plurality of channels 224 extending through the thickness of the layer. For example, the first layer 204 includes ribs 226 extending longitudinally in the Z-direction and spaced apart in the X-direction to define the channels 224 therebetween. The second layer 208 includes ribs 228 extending longitudinally in the X-direction and spaced apart in the Z-direction to define the channels 224 therebetween. The channels 224 are in flow communication with each other and form a plurality of fluid flow paths for fluid to flow through the multi-material structure 200. The fluid may include one or more reactants that interact with the first material 206 and/or the second material 210 as the fluid flow through the channels.

The grid patterns in adjacent layers 202 are offset such that the channels 224 define tortuous flow paths through the multi-material structure 200. For example, in the illustrated embodiment, the grid pattern of the first layer 204 is offset from the grid pattern of the second layer 208 by 90°, i.e., the ribs 226 are perpendicular to the ribs 228. The third, fifth, and seventh layers each include the same grid pattern as the first layer 204. The fourth, sixth, and eighth layers each include the same grid pattern as the second layer 208. Accordingly, the channels 224 are at least partly occluded by the ribs 226, 228 in an adjacent layer 202 to form the tortuous flow paths. The tortuous flow paths may increase the contact between the reactants entrained in the fluid flow and the first material 206 and the second material 210. In alternative embodiments, the layers 202 may have any patterns that enable the multi-material structure 200 to function as described herein. For example, in some embodiments, each layer 202 includes a plurality of cells.

In the illustrated embodiment, the multi-material structure 200 is a cylinder. The shape and size of the multi-material structure 200 may allow the multi-material structure to fit within an apparatus for a reactionary process such as in a conduit for fluid flow. The shape and size of the multi-material structure 200 may be precisely controlled and customized for specific applications because the multi-material structure 200 is fabricated using an additive manufacturing process which does not have the same design constraints as other methods to fabricate structures. In alternative embodiments, the multi-material structure 200 may have any shape that enables the multi-material structure to function as described herein.

### EXAMPLE

In one embodiment, multi-material structures were formed using the additive manufacturing system 10 (shown in FIG. 1). A first multi-material structure was fabricated using a copper metal organic framework (HKUST-1), a second multi-material structure was fabricated using a nickel metal organic framework (MOF-74), and a third multi-material structure was fabricated using zeolite 5A. Initially, the copper metal organic framework, the nickel metal organic, and the zeolite 5A were synthesized solvothermally and activated. Binders and solvents were selected for each of the materials. For example, Bentonite clay (BC) was used as an inorganic binder, Methylcellulose (MC) was used as a plasticizing organic binder, and poly(vinyl) alcohol (PVA) was used as a co-binder. Deionized (DI) water or DI water mixed with methanol (MeOH) was used as a solvent. Table 1 provides the weight and percentages for the binders and solvents for each respective active agent.

TABLE 1

| | Support | Bentonite | PVA | MC | |
|---|---|---|---|---|---|
| Active | (wt. | Clay (wt. | (wt. | (wt. | Solvent |
| Agent | %) | %) | %) | %) | (vol. %) |
| Zeolite | 81 | 14 | 4.0 | 3.0 | DI water |
| 5A | | | | | (200) |
| HKUST-1 | 70 | 25 | 2.5 | 2.5 | DI |
| | | | | | water/MeOH |
| | | | | | 50/50 |
| MOF-74 | 65 | 30 | 2.5 | 2.5 | DI |
| | | | | | water/MeOH |
| | | | | | 50/50 |

The active agents (HKUST-1, zeolite 5A, MOF-74) and binders (BC, MC, and PVA) were dissolved into respective solvent mixtures to form a paste. For example, each mixture was treated with sonication for at least 30 min. The pastes were then rolled for 28 hours at 25° Celsius (C) to achieve binding. The pastes were densified using an overhead stirrer (IKA RW20 mixer) operating at least at 750 rotations per minute for approximately 1 hour at 60° C. Additional solvent (e.g., about 3-5 drops of DI water) was mixed in the pastes to prepare the pastes for extrusion (e.g., provide proper fluidity of the pastes).

An additive manufacturing system (e.g., an aluminum prusa I3A pro 3D printer sold by Geetech Electronics Inc.) was used to form the structures. CAD software was used to design the monolith structures and a controller was used to read the generated CAD files and control operation of the printer. The pastes were loaded into separate syringes for extrusion. For example, about 3 or 10 cubic centimeters (cc) were loaded into each syringe. A piston head was placed into each syringe after the syringe was loaded with the paste. When the printer was ready to deposit each material onto the build platform, a pressurized air flow having a pressure in a range of 0-5 bar (depending on viscosity of the material) was supplied to the syringe to extrude the material through a 0.85 mm nozzle connected to the syringe.

The materials were deposited in a series of layers to form the desired height and shape of the structure. For example, a first syringe was connected to the printer and used to deposit the first material. After printing a layer of the first material using the first syringe, the system was paused and a second syringe which contained the second material was connected. The system settings were adjusted for the second material so that the pressure supplied to the syringes and the operating parameters of the printer were optimized separately for each paste. This process was repeated for each subsequent layer to form the multi-material structure. The layers were formed with unit cells defining a plurality of apertures. Each layer included approximately 100 cells per square inch (cpsi). The completed structures each had a height of approximately 1.5 centimeters (cm).

The structures underwent heat treating to prevent cracking and improve strength. Specifically, the structures were dried at ambient temperature overnight and then heated to 200° C. for about 2 to 3 hours to crosslink the PVA. Once cooled, the composites were removed from the build platform as a monolithic structure including multiple materials. The monoliths exhibited distinct layers of each component paste and the materials in the paste. Accordingly, the samples provided unitary structures with materials having different properties that reacted to different reactants.

FIG. 5 is a top view of a binderless structure 300 formed using an additive manufacturing system. The structure 300 includes a plurality of layers 302. Each layer 302 of the structure 300 has a lattice or grid shape and defines a plurality of channels 304 extending through the thickness of the layer 302.

In the exemplary embodiment, each layer 302 includes a material 306 formed from a calcined binder and an active agent. The material 306 has a property that provides a reaction during the at least one reactionary process. The reaction is caused by the active agent in the material 306 being exposed to a reactant. For example, in some embodiments, the active agent is configured to absorb at least one reactant during the at least one reactionary process. In further embodiments, the active agent is configured to provide a catalytic conversion of at least one reactant during the at least one reactionary process. In some embodiments, the structure 300 is a photocatalyst and the material 306 is configured to interact with light. In alternative embodiments, the material 306 provides any reaction that enables the structure 300 to function as described herein.

In the exemplary embodiment, the structure 300 has been treated to calcine the binder in the material 306 such that the structure 300 is substantially free of any binder. For example, the structure 300 may be heated in a controlled environment to a temperature equal to or greater than the calcination temperature of the binder until the binder is entirely removed from the material. As a result, the structure 300 may be binderless and the material 306 may include only the active agent. Accordingly, the structure 300 may provide reactionary properties that are similar to or more reactive than pure powder forms of the material. In addition, the calcined binder may cause the formation of a plurality of pores in the binderless material 306 which may aid in the reactionary processes.

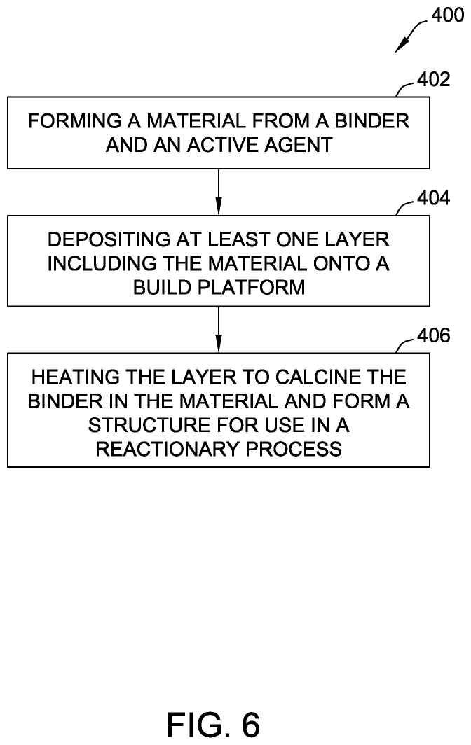

FIG. 6 is a flow chart of an example method 400 of fabricating a structure such as the structure 300. With reference to FIGS. 5 and 6, the method 400 includes forming 402 the material 306 from a binder and an active agent. For example, in some embodiments, the material 306 is formed by mixing the first active agent, the binder, and a solvent to form a paste. Method 400 includes depositing 404 at least one layer including the material 306 onto the build platform 14 (shown in FIG. 1). In some embodiments, the structure 300 includes a plurality of layers and each layer is deposited in a desired shape such as a grid pattern on the build platform 14. Successive layers may be deposited on top of previous layers. The layers may adhere to each other. For example, the binder in the material 306 in each layer may adhere to adjacent layers.

The method 400 further includes heating 406 the at least one layer to calcine the binder in the material and form a structure for use in a reactionary process. For example, the structure 300 may be heated at a controlled rate to a selected temperature. The selected temperature may be equal to or greater than the calcination temperature of the binder. In some embodiments, the structure 300 is heated in a two stage process to prevent collapse of the structure 300 and/or burnout of the active agent in the material 306. For example, the structure 300 may be heated to a first temperature and maintained isothermally at the first temperature for at least a selected time. After the selected time, the structure may be heated to a second temperature greater than the first temperature.

In addition, heating 406 the structure 300 may control the curing process for the material 306. In some embodiments, the structure 300 may be cured prior to heating 406 to calcine the binder. When the material 306 is cured and the binder is completely calcined, the structure 300 may be a solid monolith structure including only the material 306 which is free of any binder. In addition or alternatively, heat treating the structure 300 may provide a desired characteristic to the structure 300 such as a hardness. In alternative embodiments, the structure 300 may undergo any suitable treatment processes.

### EXAMPLE

In one embodiment, binderless structures were formed using the additive manufacturing system 10 (shown in FIG. 1). A first structure was fabricated using zeolite 13X (13X), a second structure was fabricated using zeolite 5A (5A), and a third structure was fabricated using zeolite ZSM-5 (ZSM-5). Binders and solvents were selected for each of the materials. For example, gelatin and pectin biopolymers were used as organic binders. Deionized (DI) water and/or dimethlyformamide (DMF) was used as a solvent. Table 2 provides the weight and percentages for the binders and solvents for each respective active agent.

TABLE 2

| | Zeolite | Pectin | Gelatin | DI | DMF |
|---|---|---|---|---|---|
| Monolith | (wt. %) | (wt. %) | (wt. %) | (mL) | (mL) |
| 13X | 66.7 | 13.3 | 20.0 | 5 | 1.5 |
| 5A | 92.1 | 2.9 | 5.0 | 5 | 0 |
| ZSM-5 | 75.0 | 25.0 | 0 | 2.5 | 2.5 |

The active agents (13X, 5A, and ZSM-5) and binders (pectin and gelatin) were mixed with solvents to form a paste. For example, the active agents and the binders were placed in containers and the solvents were added dropwise and the mixture was stirred using a spatula to produce a printable paste of the materials.

Using an additive manufacturing system (e.g., an aluminum prusa I3A pro 3D printer sold by Geetech Electronics Inc.), the materials were deposited in a series of layers to form the desired height and shape of the structure. The layers were formed with unit cells defining a plurality of apertures. The completed structures each had a height of approximately 1 centimeter (cm).

The structures underwent heat treating to calcine the binders. For example, the structures were dried at 25° overnight. After drying, the structures were heated to 350° C. at a rate of 3° C./min. The structures were maintained isothermally for at least 1 hour to burn out or calcine the binders. Then the structures were heated to 550° C. at a rate of 3° C./min and maintained isothermally for at least 5 hours. Once cooled, the treated structures were monolithic structures which were free of binders and included only active agents. Accordingly, the structures had properties that were similar to pure powder forms of the active agent with the benefits of an additively manufactured structure. Table 3 provides the textural properties of zeolite powders, monolith structures including binders (uncalcined), and binderless monolith structures (calcined).

TABLE 3

| | | | | NLDFT |
|---|---|---|---|---|
| | S_{BET} | V_{p-micro} | Vₚ₋ₘₑₛₒ | Pore Size |
| Sample | (m²/g) | (cm³/g) | (cm³/g) | (nm) |
| 13X Powder | 520 | 0.25 | 0.08 | 2, 10 |
| 13X Monolith (Uncalcined) | 150 | 0.05 | 0.06 | 2-10 |
| 13X Monolith (Calcined) | 500 | 0.30 | 0.02 | 2, 10 |
| 5A Powder | 660 | 0.32 | 0.00 | 2 |
| 5A Monolith (Uncalcined) | 130 | 0.05 | 0.03 | 2, 4, 6 |
| 5A Monolith (Calcined) | 540 | 0.26 | 0.01 | 2, 15 |
| ZSM-5 Powder | 470 | 0.15 | 0.15 | 2 |
| ZSM-5 Monolith (uncalcined) | 160 | 0.06 | 0.09 | 2, 6, 8 |
| ZSM-5 Monolith (calcined) | 390 | 0.15 | 0.12 | 2 |

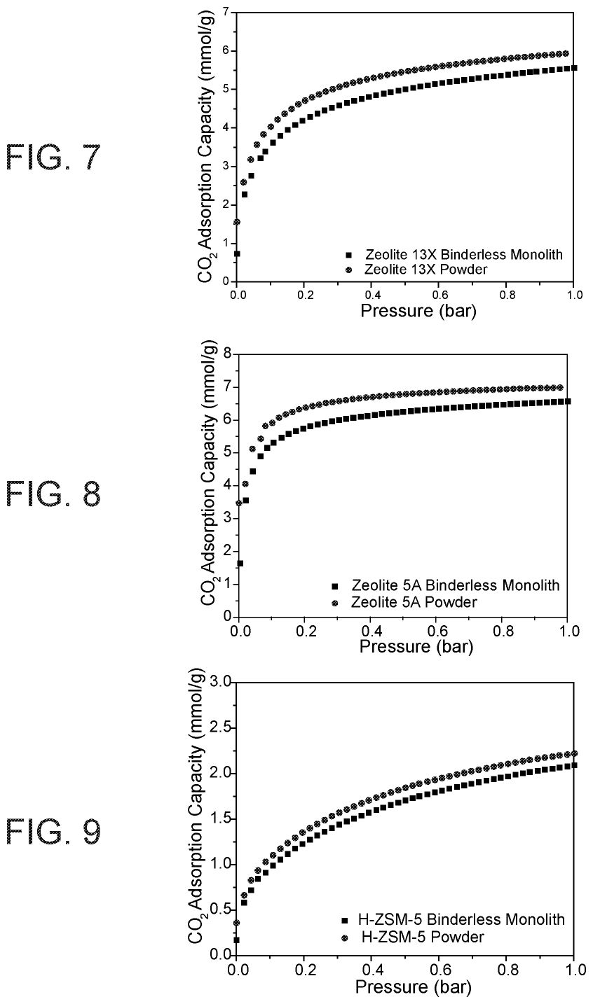

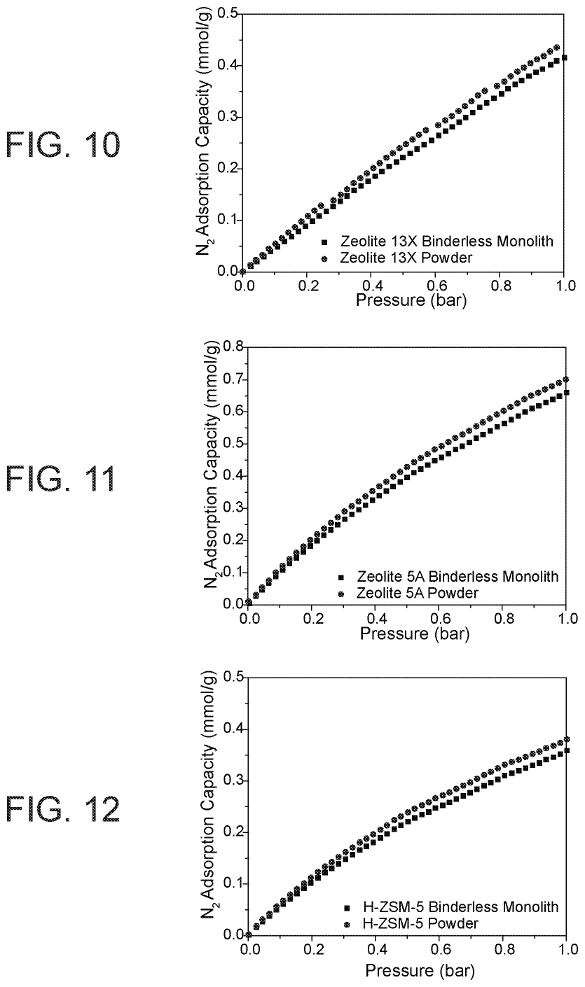

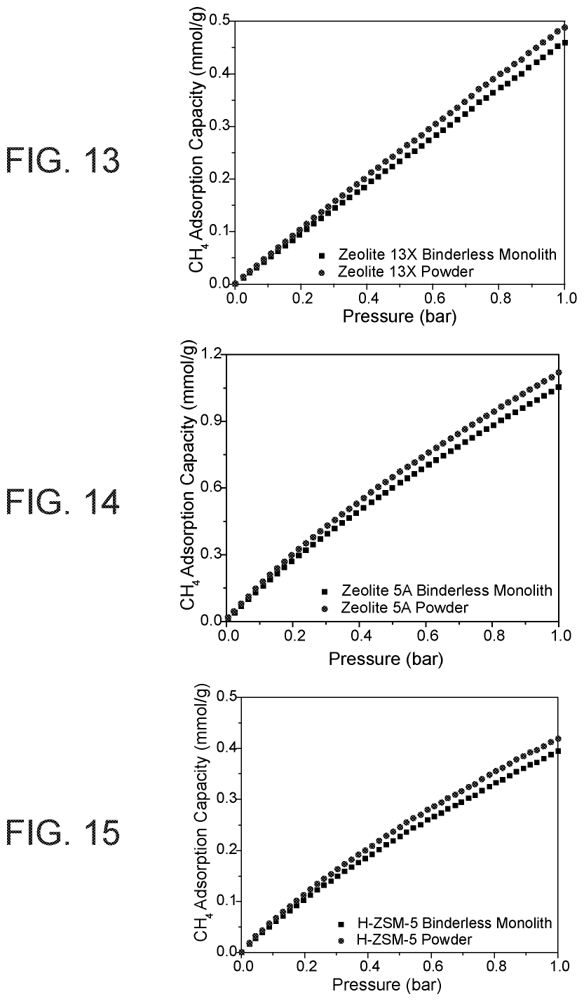

Moreover, in at least some instances, the binderless monolith structures provided increased adsorption properties in comparison to powder forms of the active agents. For example, as seen in FIGS. 7-15, the binderless structures (zeolite 13X binderless monolith, zeolite 5A binderless monolith, ZSM-5 binderless monolith) exhibited comparable adsorption capacity for CO₂, N₂, and CH₄ than the pure powders analogues (zeolite 13X powder, zeolite 5A powder, ZSM-5 powder).

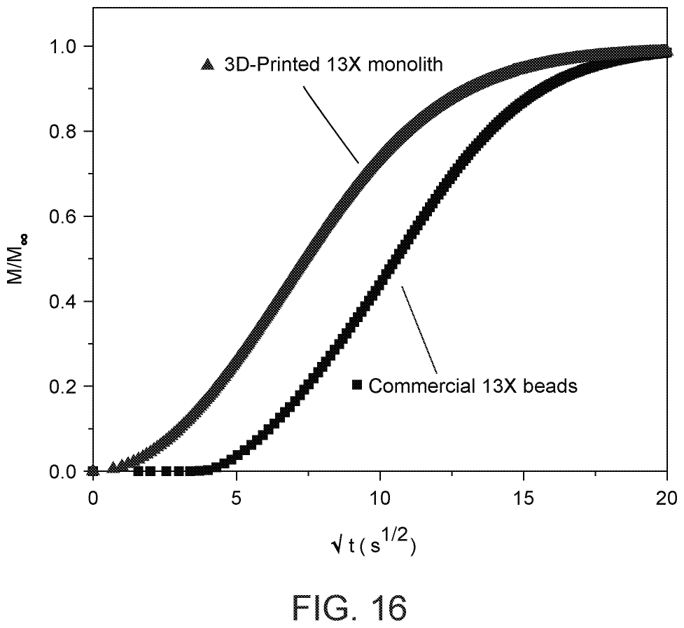

FIG. 16 shows a comparison of the adsorption kinetics for zeolite 13X binderless monolith structures and zeolite 13X beads. For example, the CO₂ uptakes for the binderless monolith structures and the beads were normalized at 25° C. under 10% CO₂/N₂. The binderless monolith structures include macroporosity which is formed during calcination and reduce resistance to molecular mass transfer. As a result, the binderless monoliths saturate at approximately twice the rate of the beads and approximately four times the rate of other monolith structures.

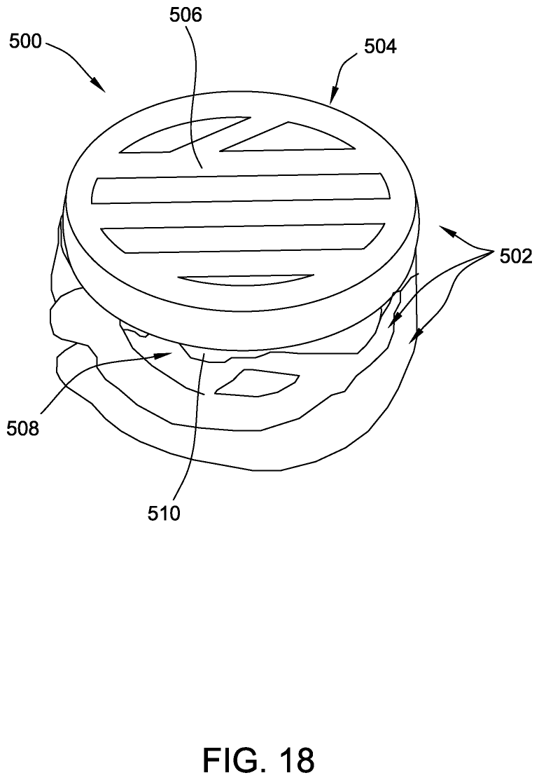

FIG. 17 is a top view of a binderless multi-material structure 500 formed using an additive manufacturing system. FIG. 18 is a perspective view of the binderless multi-material structure 500. The multi-material structure 500 includes a plurality of layers 502 and two or more different materials. For example, the multi-material structure 500 includes a first layer 504 including a first material 506 formed from a calcined first binder and a first active agent, and a second layer 508 including a second material 510 formed from a calcined second binder and a second active agent. The layers 502 are arranged in a stacked configuration such that the material of each layer 502 is in contact with and adhered to the material of an adjacent layer(s) 502 (i.e., each layer 502 contacts a layer that is above or below the layer). In the exemplary embodiment, the materials 506, 510 are adhered together such that the layers 502 are permanently joined together, i.e., the layers 502 cannot be separated without damaging the multi-material structure 500.

The multi-material structure 500 is configured to provide multiple reactions when the multi-material structure 500 is exposed to at least one reactant. For example, the first material 506 has a first property that provides a first reaction during the at least one reactionary process. The first reaction is caused by the first active agent in the first material 506 being exposed to a reactant. For example, in some embodiments, the first agent is configured to absorb at least one reactant during the at least one reactionary process. In further embodiments, the first active agent is configured to provide a catalytic conversion of at least one reactant during the at least one reactionary process. In alternative embodiments, the first material 506 provides any reaction that enables the multi-material structure 500 to function as described herein.

The second material 510 has a second property that provides a second reaction during the at least one reactionary process. The second reaction is caused by the second active agent in the second material 210 being exposed to a reactant. For example, in some embodiments, the second agent is configured to absorb at least one reactant during the at least one reactionary process. In further embodiments, the second active agent is configured to provide a catalytic conversion of at least one reactant during the at least one reactionary process. In alternative embodiments, the second material 510 provides any reaction that enables the multi-material structure 500 to function as described herein.

In some embodiments, the structure 500 is a photocatalyst and at least one of the materials 506, 510 is configured to interact with light. In alternative embodiments, the structure 500 provides any reaction that enables the structure 500 to function as described herein.

In the exemplary embodiment, the structure 500 has been treated to calcine the binder in the first material 506 and the second material 510 such that the structure 500 is substantially free of any binder, i.e., the structure is binderless. For example, the structure 500 may be heated in a controlled environment to calcine the binder within the first material 506 and the second material 510 until the binder is entirely removed from the materials. As a result, the structure 500 may include binderless materials 506, 510 including only the active agents. The calcined binder may cause the formation of a plurality of pores in the binderless material 306. Accordingly, the structure 500 has reactionary properties that are similar to pure powder forms of the material.

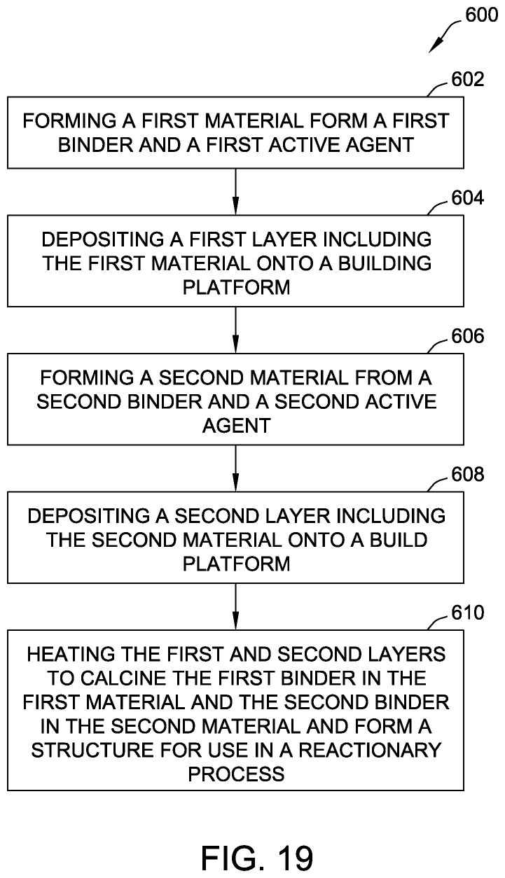

FIG. 19 is a flow chart of an example method 600 of fabricating a structure such as the structure 500. With reference to FIGS. 17-19, the method 600 includes forming 602 the first material 506 from a first binder and a first active agent. For example, in some embodiments, the first material 506 is formed by mixing the first active agent, the first binder, and a solvent to form a paste. Method 600 includes depositing 604 the first layer 504 including the first material 506 onto the build platform 14 (shown in FIG. 1).

In some embodiments, the structure 500 includes a plurality of layers and each layer is deposited in a desired shape such as a grid pattern on the build platform 14 (shown in FIG. 1). Successive layers may be deposited on top of previous layers. The layers may adhere to each other. For example, the binder in the material 506 in each layer may adhere to adjacent layers.

In the exemplary embodiment, the method 600 includes forming 606 the second material 510 from a second binder and a second active agent. For example, in some embodiments, the second material 510 is formed by mixing the second active agent, the second binder, and a solvent to form a paste. Method 600 includes depositing 608 the second layer 508 including the second material 510 onto the build platform 14 (shown in FIG. 1).

The method 100 further includes heating 610 the first and second layers to calcine the first binder in the first material and the second binder in the second material and form a structure for use in a reactionary process. For example, the structure 500 may be heated at a controlled rate to a selected temperature in a controlled environment. The selected temperature may be equal to or greater than the calcination temperature of the first binder and/or the second binder. In some embodiments, the structure 500 is heated in a two stage process to prevent collapse of the structure 500 and/or burnout of active agents in the materials 506, 510. For example, the structure 500 may be heated to a first temperature and maintained isothermally at the first temperature for a selected time. After the selected time, the structure may be heated to a second temperature greater than the first temperature.

In addition, heating 610 the structure 500 may control the curing process for the materials 506, 510. In some embodiments, the structure 500 is cured prior to heating 610 to calcine the binders. When the materials 506, 510 are cured and the binders are completely calcined, the structure 500 may be a solid monolith structure including only the materials 506, 510 without any binder. In addition or alternatively, heat treating the structure 500 may provide a desired characteristic to the structure 500 such as a hardness. In alternative embodiments, the structure 500 may undergo any suitable treatment processes.

### EXAMPLE

In one embodiment, binderless multi-material structures were formed using the additive manufacturing system 10 (shown in FIG. 1). A first structure was fabricated using potassium calcium (K—Ca) and a second structure was fabricated using zeolite ZSM-5 (10%Cr@ZSM-5). Binders and solvents were selected for each of the materials. For example, bentonite and methylcellulose biopolymers were used as organic binders. Deionized (DI) water was used as a solvent. Table 4 provides the weight and percentages for the binders and solvents for each respective active agent.

TABLE 4

| | H-ZSM-5 | K—Ca | Cr₂O₃ | Bentonite | Methylcellulose | DI |
|---|---|---|---|---|---|---|
| Paste | (wt. %) | (wt. %) | (wt. %) | (wt. %) | (wt. %) | (mL) |
| K—Ca | 0.0 | 71.9 | 0.0 | 25.4 | 2.7 | 10 |
| 10%Cr@ZSM-5 | 72.9 | 0.0 | 8.1 | 16.2 | 2.8 | 10 |

To provide the K—Ca agent, a double salt was synthesized. For example, a first mixture was formed by dissolving 1.57 g of potassium hydroxide (KOH) in 20 mL of water. A second mixture was formed by dissolving 49.33 g of calcium nitrate (Ca(NO₃)₂.4H₂O) and 24.19 g of potassium carbonate (K₂CO₃) in 20 mL of water. After observing full dissolution of the calcium salt, the potassium hydroxide mixture was added dropwise to the calcium nitrate/potassium carbonate mixture. After the KOH solution had been completely added, the resulting salt mixture was stirred at 700 rpm for 1 h, filtered, and dried overnight at 170° C. The dried salt mixture was calcined in air at 700° C. for 5 h using a ramp rate of 10° C./min. Then, the resulting salt was ground with a mortar and pestle and formed to provide the K—Ca.

The active agents (K—Ca and ZSM-5) and binders (bentonite clay) were dissolved into respective solvent mixtures to form a paste. Pastes were formulated from the active agents, binder, and solvents using the ratios in Table 4 and were rolled at room temperature for 24 h to achieve homogeneity.

Using an additive manufacturing system (e.g., an aluminum prusa I3A pro 3D printer sold by Geetech Electronics Inc.), the materials were deposited in a series of layers in an alternating pattern to form the desired height and shape of the structure. For the K—Ca paste, the extrusion pressure was 1 bar. For the Cr@ZSM-5 paste, the extrusion pressure was 2.8 bar. Both pastes were printed using a printing speed of 30% of the maximum speed of the printer. The layers were formed with unit cells defining a plurality of apertures. The completed structures each had a height of approximately 1 centimeter (cm).

The structures underwent heat treating to calcine the plasticizing agent (e.g., methylcellulose which is used to reduce shear thickening of the paste) and to sinter bonds between the active support(s) and binding agent(s). For example, the structures were dried at 25° overnight. After drying, the structures were heated to 700° C. at a rate of 10° C./min. The structures were maintained isothermally for at least 5 hours to burn out or calcine the binders. Then the structures were heated to 550° C. at a rate of 3° C./min and maintained isothermally for at least 5 hours. Once cooled, the treated structures were monolithic structures which were free of binders and included only active agents. For example, the monolith structures were cylinders and had a height of approximately 0.5 cm and a width of approximately 0.75 cm.

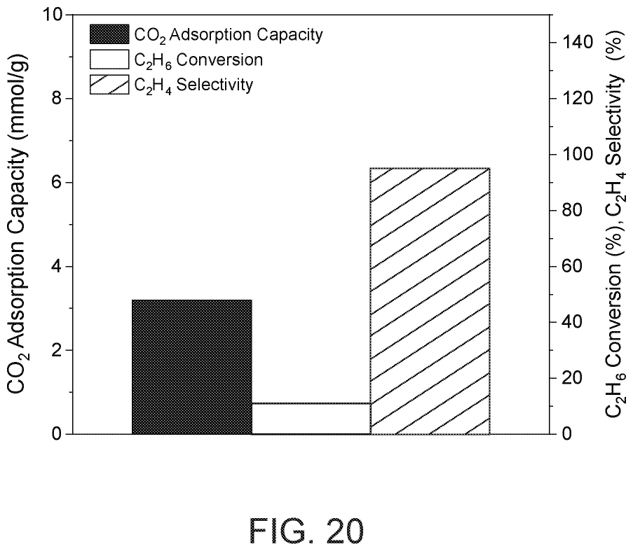

FIG. 20 shows reactive properties of the binderless multi-material monolithic structure. The structure was used for a reactionary process including combined CO₂ adsorption and oxidative dehydrogenation of ethane into ethylene. For example, for the adsorption reaction, the monolith was degassed under 35 mL/min of argon (Ar) fluid flow at 700° C. for 1 h at a heating rate of 20° C./min. The Ar fluid flow was continued into the reactor and the system was allowed to cool down at the rate of −3° C./min until the temperature reached 600° C. Next, 35 mL/min of 10% CO_{2/}Ar was directed into the reactor at 600° C. until full saturation was observed on a mass spectrometer. After full saturation, the reactor was heated to 700° C. at 30° C./min and simultaneously the flow of 10% CO2/Ar was shut off and 35 mL/min of 5% C2H6/Ar was directed into the reactor. The reaction was allowed to progress until the CO2 concentration in the effluent gas dropped to zero. As seen in FIG. 20, the monolith was capable of both adsorbing CO₂ as well as catalytically dehydrogenating ethane into ethylene.

The systems and methods described herein may be used to form structures for any reactionary processes and not just those described herein. For example, the additively-manufactured structures may be used for photocatalytic absorbents in borosilicate glass and metal organic frameworks (MOF) composites, photocatalytic absorbents in borosilicate and zeolite composite systems, simultaneous adsorption and catalytic conversion of carbon dioxide on zeolite structures, for Zeolite/metal oxide systems, and for enhanced methane storage capacity for copper MOF and graphene oxide composites.

When introducing elements of the present disclosure or the preferred embodiment(s) thereof, the articles “a”, “an”, “the”, and “said” are intended to mean that there are one or more of the elements. The terms “comprising,” “including”, and “having” are intended to be inclusive and mean that there may be additional elements other than the listed elements.

As various changes could be made in the above constructions without departing from the scope of the disclosure, it is intended that all matter contained in the above description or shown in the accompanying drawings shall be interpreted as illustrative and not in a limiting sense.

What is claimed is:

1. A method of additively manufacturing a multi-material structure, the method comprising:
forming a first material from a first binder and a first active agent;
depositing a first layer including the first material onto a build platform;
forming a second material from a second binder and a second active agent;
depositing a second layer including the second material onto the build platform, wherein the second material is in contact with the first material; and
adhering the second material to the first material to form a multi-material structure for use in a reactionary process, wherein the first material provides a first reaction during the reactionary process and the second material provides a second reaction during the reactionary process.

2. The method of claim 1, wherein depositing the first layer onto the build platform comprises depositing the first layer onto the build platform in a first grid pattern, the first grid pattern including first channels that extend through a thickness of the first layer.

3. The method of claim 2, wherein depositing the second layer onto the build platform comprises depositing the second layer onto the build platform in a second grid pattern, the second grid pattern including second channels that extend through a thickness of the second layer.

4. The method of claim 3, further comprising aligning the first grid pattern of the first layer and the second grid pattern of the second layer such that the first channels and the second channels are offset and in flow communication to form tortuous flow paths through the multi-material structure.

5. The method of claim 1, further comprising:
forming a third material from a third binder and a third active agent;
depositing a third layer onto the build platform, the third layer including the third material; and
adhering the third material to at least one of the first material and the second material, wherein the third material provides a third reaction during the reactionary process.

6. The method of claim 1, further comprising heat treating the multi-material structure after adhering the second material to the first material.

7. The method of claim 1, wherein the first active agent is configured to absorb at least one reactant during the reactionary process.

8. The method of claim 1, wherein the first active agent is configured to provide a catalytic conversion of at least one reactant during the reactionary process.

9. The method of claim 1, wherein the multi-material structure is configured to be used as a photocatalyst.

10. An additively manufactured multi-material structure for use in a reactionary process, the multi-material structure comprising:
a first layer including a first material formed from a first binder and a first active agent; and
a second layer including a second material formed from a second binder and a second active agent, wherein the second material is in contact with and adhered to the first material, wherein the first material provides a first reaction during the reactionary process and the second material provides a second reaction during the reactionary process.

11. The multi-material structure of claim 10, wherein the first layer defines a first grid pattern including first channels that extend through a thickness of the first layer.

12. The multi-material structure of claim 11, wherein the second layer defines a second grid pattern including second channels that extend through a thickness of the second layer.

13. The multi-material structure of claim 12, wherein the first grid pattern of the first layer and the second grid pattern of the second layer are aligned such that the first channels and the second channels are offset and in flow communication to form tortuous flow paths through the multi-material structure.

14. The multi-material structure of claim 10, further comprising a third layer formed from a third material including a third binder and a third active agent, the third material adhered to at least one of the first material and the second material, wherein the third material provides a third reaction during the reactionary process.

15. The multi-material structure of claim 10, wherein the first active agent is configured to absorb at least one reactant during the reactionary process.

16. The multi-material structure of claim 10, wherein the first active agent is configured to provide a catalytic conversion of at least one reactant during the reactionary process.

17. The multi-material structure of claim 10, wherein the multi-material structure is a photocatalyst.

18. A method of using an additively manufactured multi-material structure, the method comprising:
providing a multi-material structure constructed of a plurality of layers, the multi-material structure including a first material and a second material in contact with and adhered to the first material; and
channeling a fluid flow including at least one reactant through the multi-material structure such that the first material and the second material are exposed to the reactant, wherein the first material causes a first reaction and the second material causes a second reaction when the fluid flow is directed through the multi-material structure.

19. The method of claim 18, further comprising absorbing the at least one reactant into the multi-material structure.

20. The method of claim 18, further comprising causing a catalytic conversion of the at least one reactant when the fluid flow is channeled through the multi-material structure.

21. A method of additively manufacturing a structure, the method comprising:
forming a material from a binder and an active agent;
depositing at least one layer including the material onto a build platform; and
heating the at least one layer to calcine the binder in the material and form a structure for use in a reactionary process, wherein the material provides a reaction during the reactionary process.

22. The method of claim 21, wherein depositing at least one layer includes depositing a plurality of layers each including the material.

23. The method of claim 21, wherein the material is a first material including a first binder and a first active agent, the method further comprising:
forming a second material from a second binder and a second active agent;
depositing a second layer including the second material onto the build platform, wherein the second material is in contact with the first material; and
adhering the second material to the first material to form a multi-material structure for use in a reactionary process, wherein the first material provides a first reaction during the reactionary process and the second material provides a second reaction during the reactionary process.

24. The method of claim 21, wherein heating the at least one layer to calcine the binder in the material and form a structure for use in a reactionary process comprises:
heating the at least one layer to a first temperature;
maintaining the at least one layer at the first temperature for a period of time; and
heating the at least one layer to a second temperature greater than the first temperature.

25. An additively manufactured binderless structure for use in a reactionary process, the binderless structure comprising at least one layer including a material formed from a calcined binder and an active agent, wherein the material provides a reaction during the reactionary process.

26. The binderless structure of claim 25, wherein the material includes a plurality of pores formed by the calcined binder.

27. The binderless structure of claim 25, wherein the at least one layer comprises:
a first layer including a first material formed from a first calcined binder and a first active agent; and
a second layer including a second material formed from a second calcined binder and a second active agent, wherein the second material is in contact with and adhered to the first material, and wherein the first material provides a first reaction during the reactionary process and the second material provides a second reaction during the reactionary process.
